(19) United States
(12) Patent Application Publication
(10) Pub. No.: US 2026/0043444 A1
(43) Pub. Date: Feb. 12, 2026

(54) DISC BRAKE SYSTEM WITH BRAKE PAD, BRAKE PAD, AND METHODS FOR THE USE AND ASSEMBLY THEREOF

(71) Applicant: Knorr-Bremse AG, Munich (DE)

(72) Inventors: Erik W. Oberdorfer, Akron, OH (US); Keith McComsey, Hinckley, OH (US); James A. Seaman, Avon, OH (US); Thomas J. Franz, Clinton, OH (US); Taylor Allen, Shaker Heights, OH (US); Lirio Martinez, Monterrey (MX); Ruben Lopez, Nuevo Leon (MX); Richard L. Lantz, Clinton, OH (US); Guang Yu Wen, Avon, OH (US)

(73) Assignee: Knorr-Bremse AG, Munich (DE)

(21) Appl. No.: 18/799,655

(22) Filed: Aug. 9, 2024

(51) Int. Cl. F16D 55/225; F16D 55/00; F16D 65/00; F16D 65/095

(52) U.S. Cl. CPC F16D 55/225; F16D 65/0056; F16D 65/095; F16D 2055/0008; F16D 2055/0016

(57) ABSTRACT

A disc brake system includes a carrier and a brake pad having a backing plate and a friction material supported by the backing plate. The backing plate and friction material are configured so as to minimize any possible interference with the caliper housing, while maximizing the strength and durability of the brake pad. A method of actuating a disc brake system is also provided.

### FIELD OF THE INVENTION

The present application relates generally to a disc brake system, and in particular to a disc brake system including a brake pad, together with methods for the use and assembly thereof.

### BACKGROUND

Disc brake systems may be configured with opposing pairs of brake pads that engage a rotor to slow and/or stop a vehicle. Such systems typically include a caliper and a carrier, which supports the brake pads. The space occupied by, and defined in, the caliper may be limited, which may contradict the need for maintaining a proper footprint and surface area of the brake pad necessary to provide adequate braking capabilities. These countervailing design features may lead to limited spacing between the caliper and brake pad, and the possibility of interference between the caliper and brake pad during installation and/or use.

In addition, many brake pads, or friction material portion thereof, are made with copper, which may generate copper particulates during use. Such particulates may be characterized as possible pollutants.

Brake pads experience repeated loads during a lifetime of use. A typical brake pad includes a backing plate, which supports the friction material. The backing plate may be susceptible to bending, deformation and/or fatigue during use. As such, improvements making the backing plate stiffer and more durable may be desirable.

### SUMMARY

The present invention is defined by the following claims, and nothing in this section should be considered to be a limitation on those claims.

In one aspect, one embodiment of a disc brake system includes a carrier having a leading pad support and a trailing pad support. The leading and trailing pad supports are spaced apart and define a pad receiving opening. The trailing pad support includes a first side having a first width and defining a carrier contact surface having a first top edge. A brake pad includes a backing plate and a friction material. The backing plate has a second side defining a backing plate contact surface with a second width and a second top edge. The friction material is supported by the backing plate and includes a third side having a third width and a third top edge. At least a portion of the brake pad is disposed in the pad receiving opening, wherein at least a portion of the carrier contact surface abuts at least a portion of the backing plate contact surface during a braking event. The second top edge is positioned below the first top edge and overlies the carrier contact surface.

In another aspect, one embodiment of a brake pad includes a backing plate having a first side defining a contact surface with a first width and a first top edge. A friction material is supported by the backing plate, wherein the friction material has a second side with a second width and a second top edge. The first top edge is positioned below the second top edge.

In another aspect, one embodiment of a method of actuating a disc brake system includes engaging a rotor rotating about an axis with inboard and outboard brake pads, wherein each of the inboard and outboard brake pads comprises a backing plate and a friction material coupled to the backing plate; applying a friction force to the inboard and outboard brake pads in response to the engaging of the rotor; and transferring the friction force applied to the inboard and outboard brake pads to a carrier by abutting a carrier contact surface of the carrier with a backing plate contact surface of the backing plate of at least one of the outboard and inboard brake pads. The carrier contact surface has a first top edge and the backing plate contact surface has a second top edge, wherein the second top edge is positioned below the first top edge and overlies the carrier contact surface.

Various other methods of using and assembling the disc brake system are also provided.

The various embodiments of the disc brake system and brake pad, and methods for the use and assembly thereof, provide significant advantages over other disc brake systems and methods. For example, and without limitation, the configuration of the brake pad, and the relationship between the backing plate, the friction material and the carrier, provides for an increase in the clearance between the backing plate and the caliper housing. At the same time, the backing plate may be made thicker, which may provide increased stiffness and durability. Finally, the friction material may be a copper free N level friction material, which minimizes and/or eliminates the release of copper particulates during braking.

The foregoing paragraphs have been provided by way of general introduction, and are not intended to limit the scope of the claims presented below. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of a disc brake system.

FIG. 2 is a top view of one embodiment of a disc brake system.

FIG. 3 is an enlarged, partial view, taken along line 3 in FIG. 2, showing the spacing between a caliper housing and a backing plate. FIG. 3 is an inboard perspective view of another embodiment of a carrier.

FIG. 4 is an end view of a carrier and a pair of brake pads.

FIG. 5 is a partial, perspective view of a brake pad.

FIG. 6 is a front view of one embodiment of a brake pad.

FIG. 7 is a top view of the brake pad shown in FIG. 6.

FIG. 8 is a bottom view of the brake pad shown in FIG. 6.

FIG. 9 is a rear view of the brake pad shown in FIG. 6.

FIG. 10 is a perspective view of the brake pad shown in FIG. 6.

FIG. 11 is a first end view of the brake pad shown in FIG. 6.

FIG. 12 is a second, opposite end view of the brake pad shown in FIG. 6.

FIG. 13 is a top perspective view of a pair of brake pads supported by a carrier.

FIG. 14 is an exploded view of a disc brake system on a left-hand side of the vehicle.

FIG. 15 is a cross-sectional view of one embodiment of a disc brake system.

FIG. 16A and B are partial, perspective views of a carrier and brake pads from outboard and inboard perspectives respectively.

FIG. 17 is an enlarged, partial view showing a corner of the backing plate.

FIG. 18 is a partial perspective view of a carrier.

### DETAILED DESCRIPTION OF THE PRESENTLY PREFERRED EMBODIMENTS

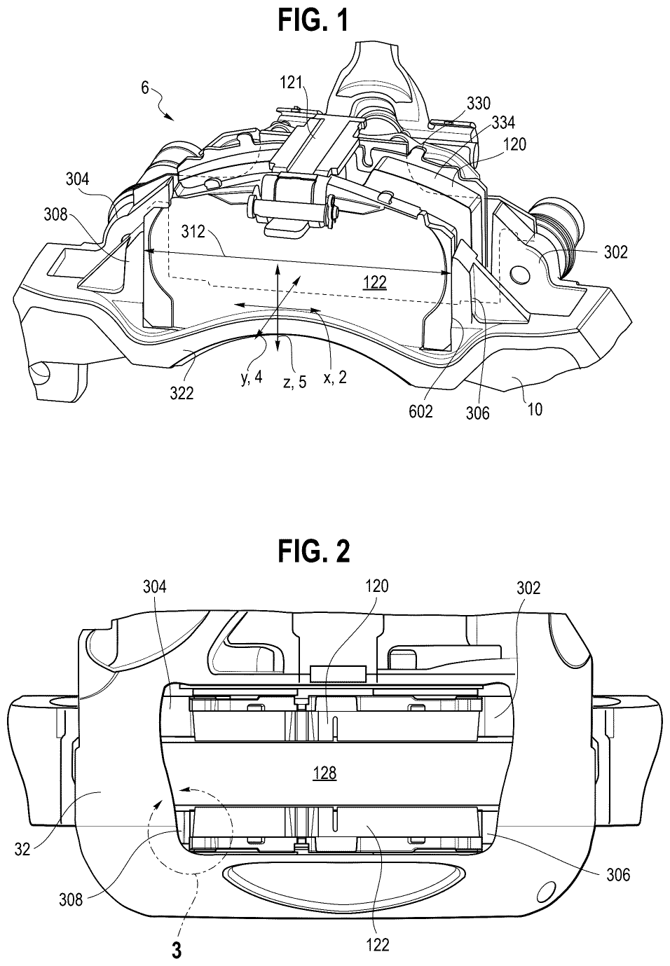

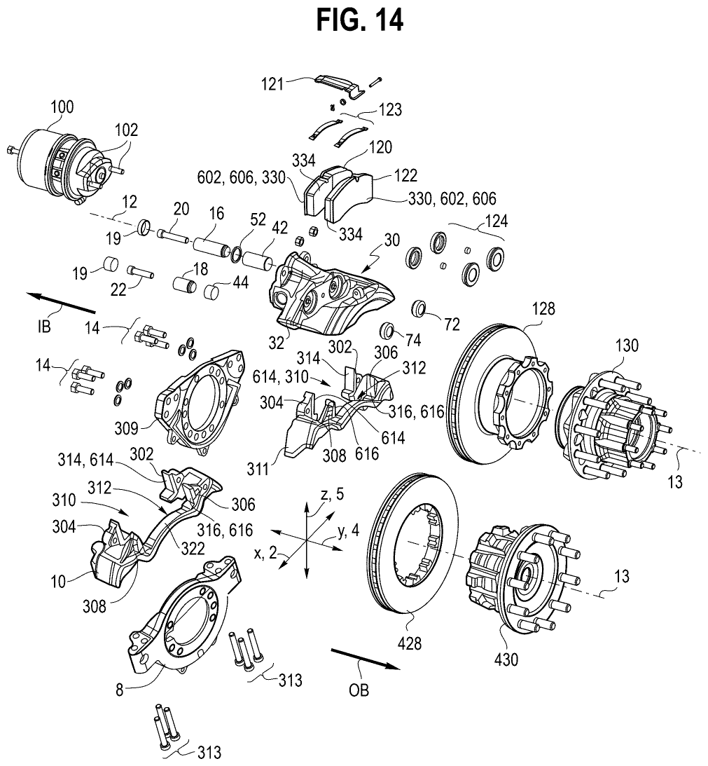

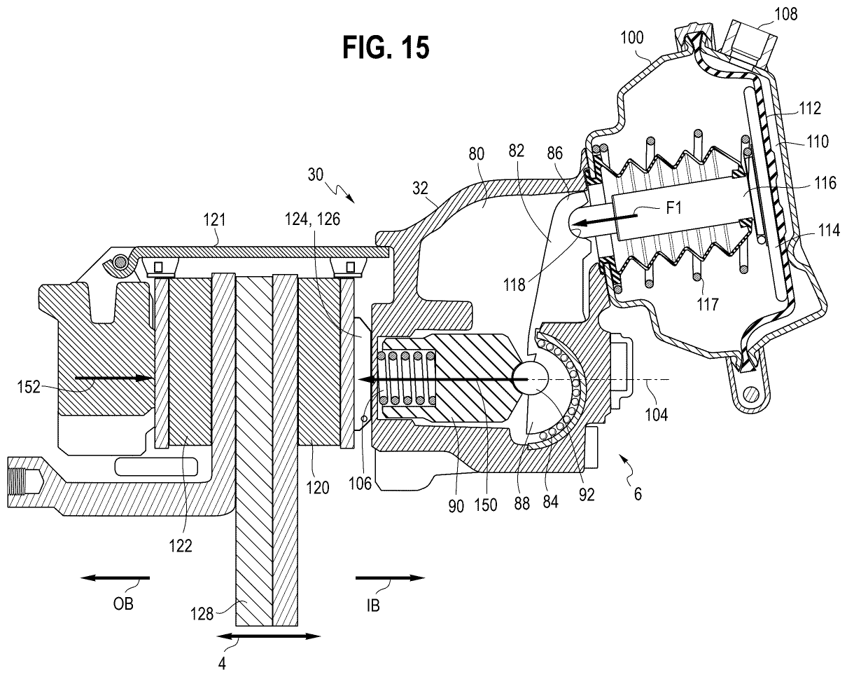

It should be understood that the term “plurality,” as used herein, means two or more. The term “longitudinal,” as used herein means of or relating to a length or lengthwise direction 2, or X direction, for example a direction running parallel to a brake pad as shown in FIG. 1. The term “lateral,” as used herein, means situated on, directed toward or running in a side-to-side direction 4, or Y direction, transverse to the longitudinal direction 2. The term “transverse” means non-parallel. The term “outboard” refers to a position or an OB direction facing outwardly away from a centralized location, for example a rotor 128, while the term “inboard” refers to a position or an IB direction facing inwardly relative to the rotor 128, as shown for example in FIGS. 14 and 15.

The term “coupled” means connected to or engaged with, whether directly or indirectly, for example with an intervening member, and does not require the engagement to be fixed or permanent, although it may be fixed or permanent. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. It should also be understood that designation of “first” and “second” does not necessarily mean that the two components or values so designated are different, meaning for example a first direction may be the same as a second direction, with each simply being applicable to different components.

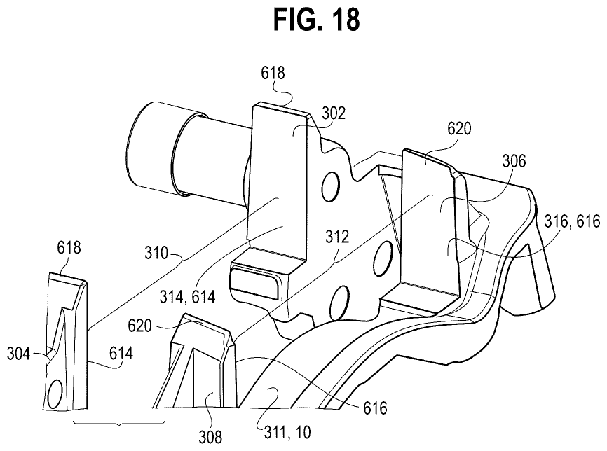

Referring to FIGS. 1, 2, 14 and 15, an air disc brake system 6 includes a torque plate 8, 309 and a carrier 10, 311 connected to the torque plate 8, 309, for example with a plurality of fasteners 14, 313, which may include a combination of bolts and washers. The fasteners 14, 313 may be oriented parallel to an axis of wheel rotation, or perpendicular to the axis. The carrier 10 has an inboard leading pad support 302, an inboard trailing pad support 304, an outboard leading pad support 306, and an outboard trailing pad support 308. It should be understood that the terms “leading” and “trailing” refer to the orientation of various components, such as the pad supports, on the carrier 10, and corresponding brake system 6, when installed on one side of the vehicle, and that the brake system 6 and carrier 10 may be installed on an opposite side of the vehicle, with the “leading” and “trailing” components being reversed. As such, a leading pad support 302 on one side of the vehicle (e.g., on the left-hand side of the vehicle as shown in FIG. 14) may be a trailing pad support on the other side (e.g., on the right-hand side of the vehicle as shown in FIGS. 13 and 18), and vice versa.

The disc brake system includes a pair of guide pins 16, 18 mounted to the carrier 10, 311 with fasteners 20, 22, shown as bolts, and extend in the axial lateral direction 4. In one embodiment, a first long guide pin 16 has a tight clearance fit and is the primary load carrying pin with a first length and a second guide pin 18 has a greater clearance and is the secondary load carrying element with a second length, with the first length being greater than the second length. In one embodiment, the guide pins 16, 18 are coupled to the carrier 311, 10 by way of the fasteners 20, 22 through a threadable engagement with the housing or with nuts positioned on an opposite side of the housing, although the guide pins may be coupled by press fit, welding or other known fastening techniques. Each guide pin 16, 18 has an outer circumferential surface. The guide pins may be cylindrical, or may have other shapes, including non-circular cross-sections. A caliper 30 includes a housing 32 having a pair of bores positioned to receive the guide pins 16, 18 respectively. A bushing 42, 44 is mounted in each bore, for example by press fit, with the bushing engaging the circumferential surface of the guide pins.

The caliper housing 32 defines a cavity 80. A lever 82 is disposed in the cavity and is supported by two eccentric bearings 84 disposed in the cavity. The lever 82 has a first portion 86, or arm, extending laterally into the cavity and a second portion 88 engaging a bridge 90, for example through a cylindrical bearing or ball joint 92. The first portion 86 is engaged by an actuator 100, which may be mounted to the caliper housing 32 with fasteners 102. The bridge 90 is biased inwardly, away from the brake pads 120, 122 along a longitudinal axis 104 by a return spring 106.

The actuator 100 includes an air supply port 108 in fluid communication with a service brake chamber 110. As air is introduced into the chamber during application of the vehicle brakes, the air applies pressure in the chamber and expands the diaphragm 112 which in turn applies a force to and moves a pressure plate 114 and pushrod 116 in an axial direction. The pushrod 116 includes a pusher tip that engages the first portion 86 of the lever cup and pushes the lever 82. The lever 82 thereafter rotates and pivots about the eccentric bearing 84 from an unactuated home position to an actuated position where the clamping load equates to the actuator input force minus internal friction losses. As the lever 82 pivots, the second portion 88 of the lever engages and moves the bridge 90 outwardly in the axial direction from a first position to a second position against the force of the return spring 106. The bridge 90 is coupled to and moves a pair of tubes and tappets 124, 126, or single tappet, in the lateral direction 4 so as to move an inner brake pad 120 in the longitudinal direction. The inner brake pad 120 engages the brake rotor 128. Further movement of the bridge 90 forces the caliper 30, sliding on the guide pins 16, 18, away from the rotor 128 in the lateral direction 4 from a non-braking position to a braking position. The sliding movement of the caliper 30 on the guide pins 16, 18 moves the outer brake pad 122 inwardly toward an opposite side of the rotor 128, thereby clamping the rotor 128 between the inner and outer brake pads 120, 122 and applying a braking force to the brake rotor 128 and attached hub 130, 430. The brake pads 120, 122 are coupled to the carrier 10, 311 and caliper with a pad retainer 121 and springs 123.

When the vehicle brakes are released, the air pressure in the service brake chamber 110 is exhausted and the return springs 117, 106 in the chamber and in the cavity acting on the bridge 90 return the air disc brake to a neutral, non-braked position. To maintain an appropriate running clearance gap between the rotor 128, 428 and the brake pads 120, 122 over time, the non-braked position may be mechanically adjusted by a mechanism in the caliper. The adjustment mechanism operates automatically whenever the brakes are activated, to compensate for rotor and brake pad wear and to keep the running clearance constant.

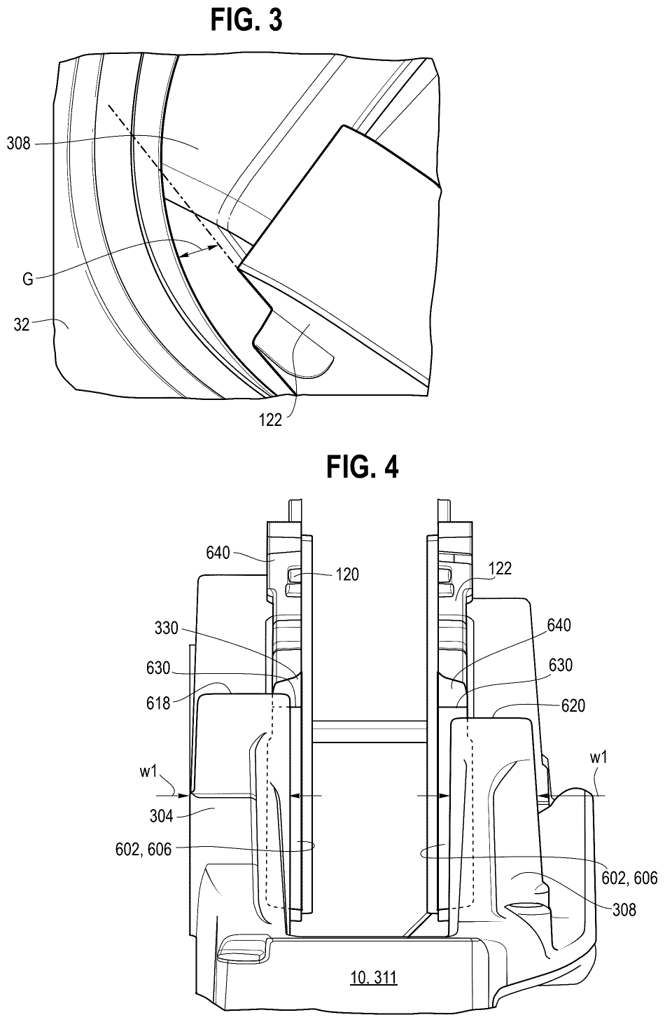

Referring to FIG. 3, a gap (G), or minimum spacing, is defined between the caliper housing 32 and the brake pad 122, and a backing plate 330 in particular. In one embodiment, and due to the configuration of the backing plate 330 and interface with the carrier 10, 311, the backing plate 330 has a minimum spacing (G) from the caliper housing 32 equal to or greater than 2 mm. As shown in FIGS. 1, 4, 13 and 14 the pad supports 302, 304, 306, 308 may be referred to as horns, in that they extend outwardly from the carrier 10, for example in a Z-direction 5. It should be understood that the X direction 2 is not necessarily horizontal, or the Z direction 5 vertical, but rather that those directions are orthogonal and may rotate about the Y axis 4 depending on the location of the disc brake system 6, which may be positioned at any orientation about the Y axis. As such, the terms “below” and “top” refer to the orientation of components modified as shown in FIG. 14, i.e., in a 12 O'clock position, but with the understanding that the disc brake system may be rotated relative to, i.e., about, the axis 13. The inboard leading and trailing pad supports 302, 304, or horns, as shown on the left-hand side in FIG. 14, are spaced apart in the longitudinal direction 2 and define an inboard pad receiving opening 310, while the outboard leading and trailing pad supports 306, 308, as shown in FIG. 14, are spaced apart in the longitudinal direction 2 and define an outboard pad receiving opening 312. As shown in FIGS. 14 and 18, for example and without limitation, the inboard and/or outboard leading pad supports 302, 306 and trailing pad supports 304, 308 may each include a carrier contact surface 614, 616, otherwise referred to as an abutment or bearing surface, defining in part a corresponding one of the inboard and/or outboard receiving openings 310, 312.

As shown in FIG. 1, an inboard brake pad 120 is disposed in the inboard pad receiving opening 310 and an outboard brake pad 122 is disposed in the outboard pad receiving opening 312. In one embodiment, shown in FIG. 14, the inboard leading and trailing pad supports 302, 304 are laterally spaced from the outboard leading and trailing pad portions 306, 308 in the lateral Y direction 4. The carrier 10 may include a beam 322 extending between and connecting the outboard leading and trailing pad supports 306, 308. Referring to the embodiment of FIGS. 1, 4, 13 and 14, both the outboard and inboard trailing pad supports 306, 302 (FIG. 13 right-hand side), 308, 304 (FIG. 14 left-hand side) define a carrier contact surface 616, 614, or abutment surface, that may be engaged by corresponding backing plate contact surface 602, or abutment surfaces, on the trailing end side 606 of the outboard and inboard backing plates 330. The trailing end side 606 is longitudinally spaced in the longitudinal X direction 2 from the leading end side 610 of the backing plates 330. It should be understood that the brake pads 120, 122 are symmetrical, such that the leading end side of the inboard brake pad 120 defines the trailing end side of the outboard brake pad 122. It should be understood, however, that the brake pads may not be symmetrical.

Referring to FIGS. 1, 14 and 18, the carrier 10, 311 may be made of cast metal, with the pad supports defined during casting. Vertical sides 606 of the brake pads 120, 122, and the backing plates 330 in particular, define backing plate contact surfaces 602 that engage vertical carrier contact surfaces 614, 616 defining the pad receiving openings 310, 312, which may be machined to finished dimensions and tolerances on both the inboard and outboard abutment surfaces. The inboard and outboard brake pads 120, 122 each include a backing plate 330 and a friction material 334 supported by the backing plate 330. At least a portion of the inboard backing plate 330 and/or inboard friction material 334 is disposed in the inboard pad receiving opening 310, while at least a portion of the outboard backing plate 330 and/or outboard friction material 334 is disposed in the outboard pad receiving opening 312. In one embodiment, the friction material is “copper free,” meaning the material is a nearly copper free N level friction material, or has less than 0.5% copper by weight. It should be understood that the friction material may be any material suitable for engaging the rotor, including friction materials including copper.

As shown, for example, in FIGS. 1, 4, and 14, one embodiment of the disc brake system includes the carrier 10, 311 configured with leading pad supports 302, 306 and trailing pad supports 304, 308. As shown in FIGS. 13 and 18, the carrier includes leading pad supports 304, 308 on the right-hand side of the vehicle. The leading and trailing pad supports 302, 306, 304, 308 are spaced apart and define the pad receiving openings 310, 312. The leading and trailing pad supports 302, 306, 304, 308 include a side 314, 316 having a width (W1) and defining the carrier contact surface 614, 616 having a top edge 618, 620. The carrier contact surface 614, 616 is defined as the surface that is parallel to the backing plate contact surface 602, and may be planar in one embodiment. The top edge 618, 620 is the upper or outer most edge where a peripheral edge deviates away from the contact surface 614, 616, or plane thereof.

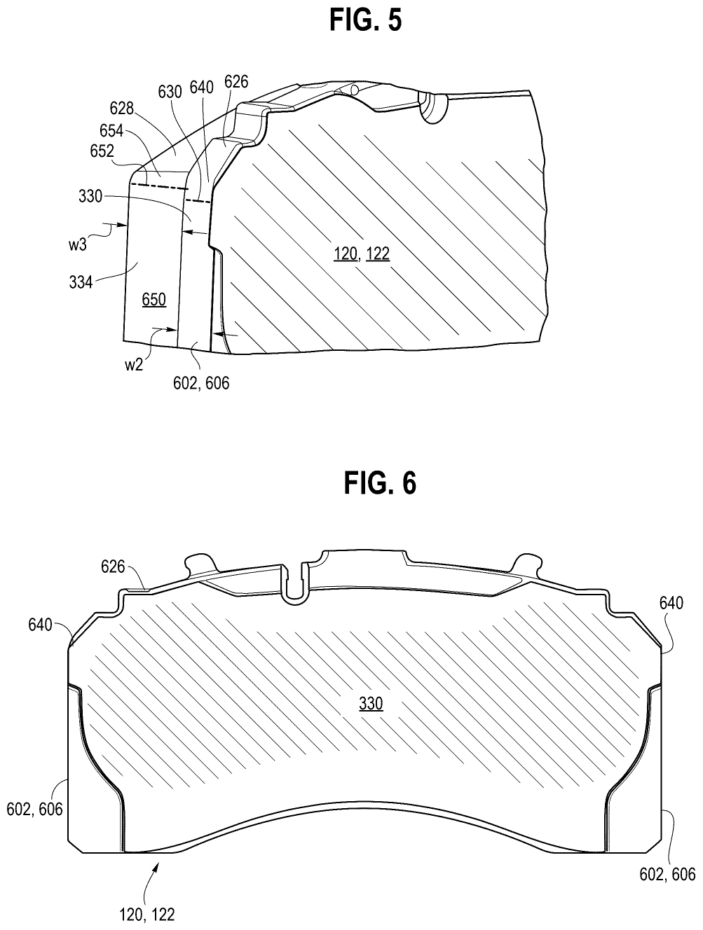

The brake pad 120, 122 includes the backing plate 330 and the friction material 334 applied thereto. The backing plate 330 includes the sides 606 defining the backing plate contact surfaces 602, each with a width (W2) and a top edge 630. The backing plate contact surface 602 is defined as the surface that is parallel to the carrier contact surface 614, 616, and may be planar in one embodiment. In one embodiment, the contact surface is at least 675 mm². The top edge 630 is the upper or outer most edge where the peripheral edge of the backing plate 330 deviates away from the contact surface 602, or plane thereof, for example at the tangent between the side 606 and a curved, or chamfered corner 640, as shown in FIGS. 4, 5 and 17. In one embodiment, both the carrier contact surface 614, 616 and the backing plate contact surface 602 are planar, although it should be understood that those contact surfaces may include deviations, such as holes or grooves, but with the top edges 618, 620, 630 terminating at the uppermost point where the surface deviates in the longitudinal direction, for example at the beginning of the chamfer or curvature 640. The chamfered or curved corner 640 is disposed between the contact surface 602 and the top peripheral surface 626 of the backing plate 330. In one embodiment of a brake pad, the top edge of the backing plate contact surface is positioned below the top edge of the friction material.

The friction material 334 is supported by the backing plate 330 and includes a side 650 having a width (W3) and a top edge 652. The top edge 652 of the friction material is the upper or outermost edge where the peripheral edge deviates away from the side 650 of the friction material, or plane thereof, for example at the tangent between the side 650 and a curved, or chamfered corner 654, as shown in FIG. 5. The chamfered or curved corner 654 is disposed between side 650 and a top peripheral surface 628 of the backing plate. In one embodiment of a brake pad, the top edge 630 of the backing plate contact surface 602 is positioned below the top edge 652 of the friction material 334.

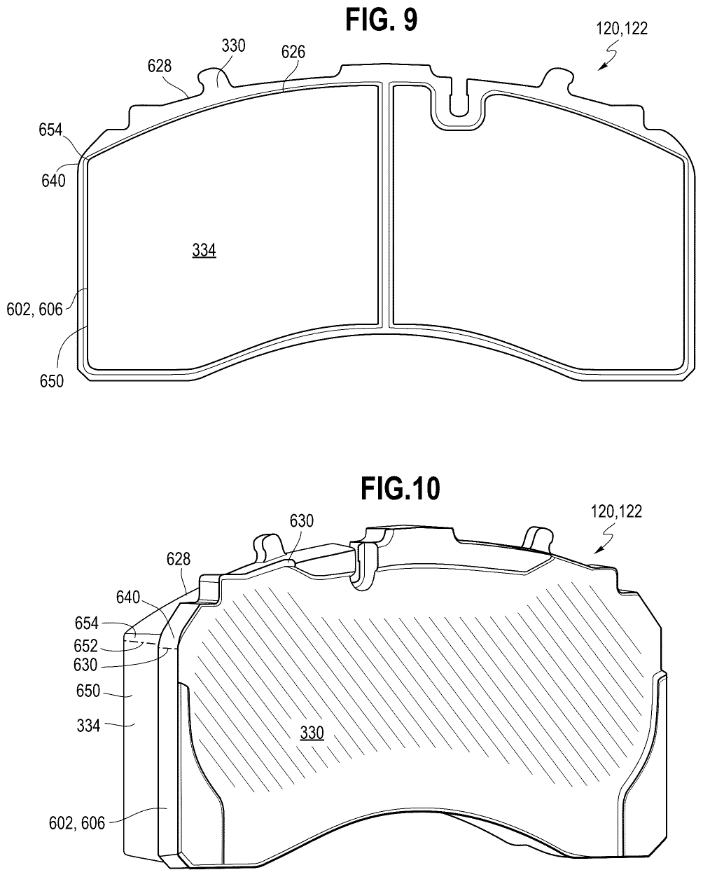

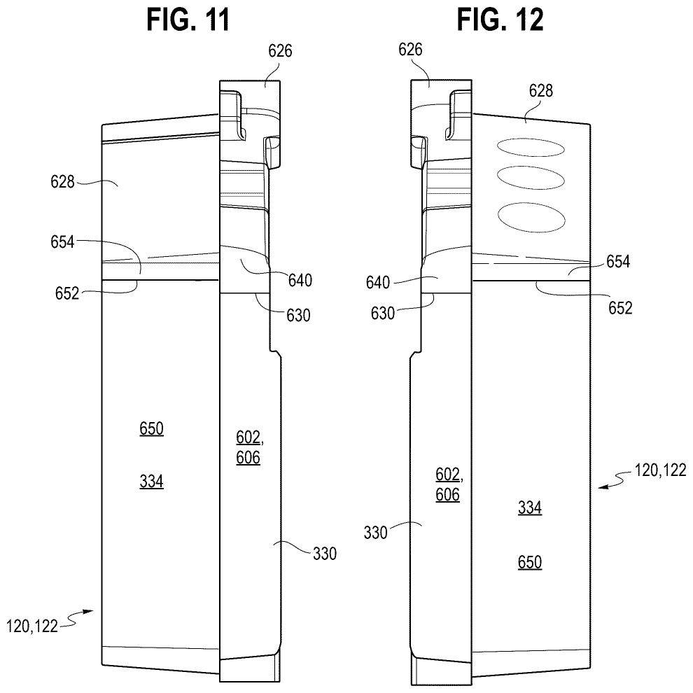

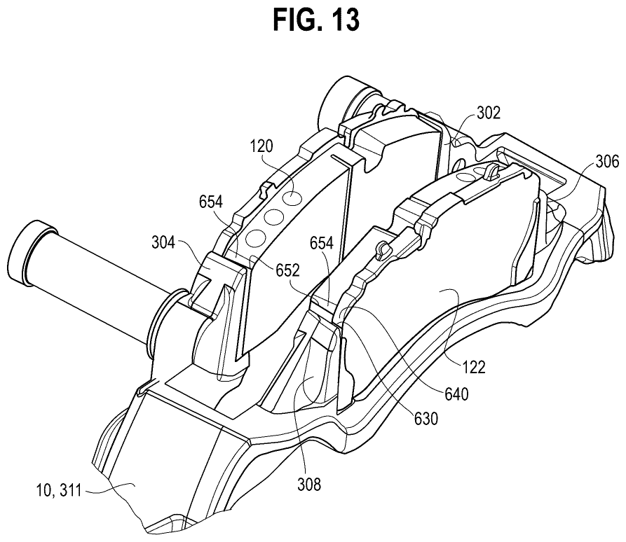

It should be understood that the shape and ornamental appearance of the front, rear, side/end, top, and bottom views of the brake pad, including the shape and ornamental appearance of the backing plate and/or friction material, as shown for example and without limitation in FIGS. 6-12, may take, or be presented in, many different forms and variations without deviating from the functional aspects herein described.

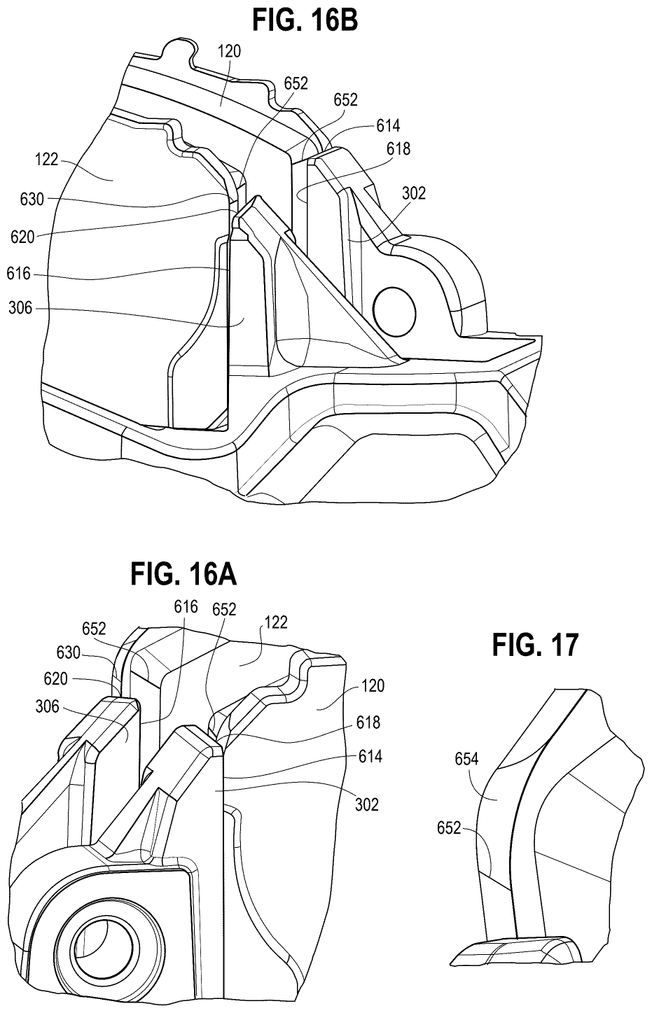

At least a portion of the brake pad is disposed in each of the pad receiving openings 310, 312. At least a portion of the carrier contact surface 614, 616 abuts, or overlaps with, at least a portion of the backing plate contact surface 602 both before and during a braking event. The amount of overlap may decrease over time as the friction material wears and the width W3 is reduced. As shown in FIGS. 4 and 16B, the top edge 630 of the backing plate contact surface is positioned below the top edge 618 of the carrier contact surface 614, at least on the IB (inboard) side and overlies the carrier contact surface 614. The top edge 630 of the backing plate contact surface 602 is positioned above the top edge 620 of the carrier contact surface 616, for example on the OB (outboard) side. In one embodiment, the width (W2) of the backing plate is at least 40% of the width (W3) of the overall friction material. In various embodiments, W2>9 mm, and in one embodiment W2=11 mm. In one embodiment, wherein W2=11mm, W2+W3=32 mm, or W2+W3=30 mm if the depth of a tappet recess is excluded. In this way, the backing plate 330 may be relatively stiff, even while lowering the top edge 630 of the backing plate contact surface 602, and the overall height of the backing plate 330. By lowering the top edge 630, additional clearance with the caliper housing 32, on both the inboard and outboard sides, is realized. At the same time, the increased width (W2) ensures adequate contact between the contact surfaces 602, 614, 616 during installation and use, including over the predetermined life expectancy of the brake pad. In one embodiment, the backing plate 330 has a minimum spacing relative to the caliper housing 32 equal to or greater than 2 mm.

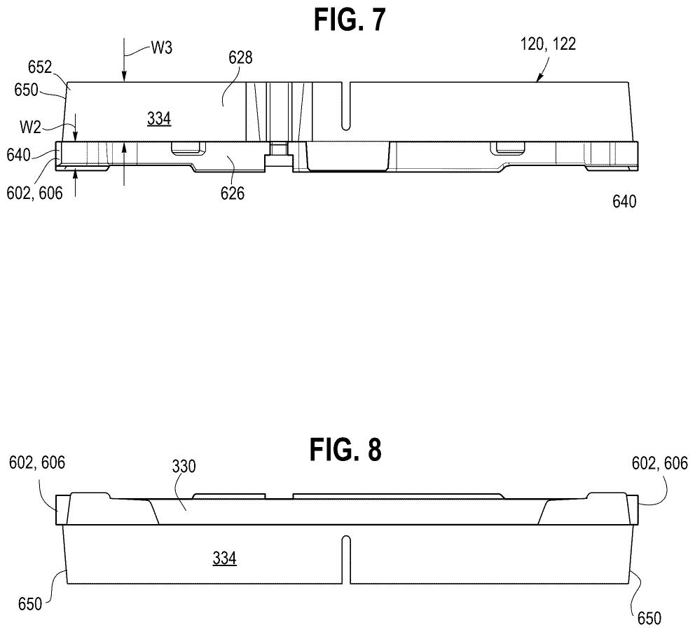

The same brake pad 120, 122 may be installed on the IB and OB side of the carrier. As noted above, the top edge 630 of the backing plate contact surface 602 may be positioned above the top edge 620 of the carrier contact surface, for example on the outboard side. In either embodiment, the top edge 630 of the backing plate contact surface is positioned below the top edge 652 of the side 650 of the friction material 334. The side 650 of the friction material may be offset longitudinally from the side 606 of the backing plate, as shown in FIGS. 7, 8 and 10.

In operation, and referring to FIGS. 14 and 15, the method of actuating the disc brake system 6 includes engaging the rotor 128 rotating about a wheel axis 13 with inboard and outboard brake pads 120. Each of the inboard and outboard brake pads 120, 122 includes the backing plate 330 and the friction material 334 coupled to the backing plate. The method further includes applying a friction force to the inboard and outboard brake pads 120, 122 in response to the engaging of the rotor and transferring the friction force applied to one of the inboard or outboard brake pads to the carrier by abutting a carrier contact surface 614, 616 of the carrier with a backing plate contact surface 602 of the backing plate of the brake pad. The carrier contact surface 614, 616 has a top edge 618, 620 and the backing plate contact surface 602 has a top edge 630, wherein the top edge 630 is positioned below the top edge 618 and overlies the carrier contact surface 614. The top edge 630 of the backing plate contact surface may also be positioned above the top edge 620 of the carrier contact surface, for example on the OB side. In either embodiment, the top edge 630 of the backing plate contact surface is positioned below the top edge 652 of the friction material side.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A disc brake system comprising:
a carrier comprising a leading pad support and a trailing pad support, wherein the leading and trailing pad supports are spaced apart and define a pad receiving opening, wherein the trailing pad support comprises a first side having a first width and defining a carrier contact surface having a first top edge;
a brake pad comprising:
a backing plate comprising a second side defining a backing plate contact surface having a second width and a second top edge; and
a friction material supported by the backing plate, wherein the friction material comprises a third side having a third width and a third top edge;
wherein at least a portion of the brake pad is disposed in the pad receiving opening, wherein at least a portion of the carrier contact surface abuts at least a portion of the backing plate contact surface at least during a braking event, wherein the second top edge is positioned below the first top edge and overlies the carrier contact surface.

2. The disc brake system of claim 1 wherein the second top edge is positioned below the third top edge.

3. The disc brake system of claim 1 wherein the second width is at least 40% of the third width.

4. The disc brake system of claim 1 wherein each of the leading and trailing pad supports are inboard leading and trailing pad supports, and wherein the carrier comprises an outboard leading pad support and an outboard trailing pad support, wherein the outboard leading and trailing pad supports are spaced apart and define an outboard pad receiving opening, wherein the outboard trailing pad support comprises a fourth side having a fourth width and defining a second carrier contact surface having a fourth top edge, wherein the brake pad comprises a first brake pad, and further comprising a second brake pad having second backing plate and a second friction material, wherein at least a portion of the second brake pad is disposed in the outboard pad receiving opening, wherein at least a portion of a second backing plate contact surface of the second backing plate abuts at least a portion of the second carrier contact surface during the braking event, wherein a top edge of the second backing plate contact surface is positioned above the fourth top edge such that the fourth top edge overlies the contact surface of the second backing plate.

5. The disc brake system of claim 4 further comprising a caliper housing supporting the carrier, wherein the second backing plate contact surface and/or the top edge of the second backing plate contact surface has a minimum spacing from the caliper housing, wherein the minimum spacing is equal to or greater than 2 mm.

6. The disc brake system of claim 1 wherein the friction material is copper free.

7. The disc brake system of claim 1 wherein the backing plate comprises a top surface and a chamfered corner disposed between the second contact surface and the top surface.

8. A brake pad comprising:
a backing plate comprising a first side defining a contact surface having a first width and a first top edge; and
a friction material supported by the backing plate, wherein the friction material comprises a second side having a second width and a second top edge;
wherein the first top edge is positioned below the second top edge.

9. The brake pad of claim 8 wherein the first width is at least 40% of the second width.

10. The brake pad of claim 9 wherein the first width is equal to or greater than 9 mm.

11. The brake pad of claim 8 wherein the friction material is copper free.

12. The brake pad of claim 8 wherein the backing plate comprises a top surface and a chamfered corner disposed between the contact surface and the top surface.

13. A method of actuating a disc brake system comprising:
engaging a rotor rotating about an axis with inboard and outboard brake pads, wherein each of the inboard and outboard brake pads comprises a backing plate and a friction material coupled to the backing plate;
applying a friction force to the inboard and outboard brake pads in response to the engaging of the rotor; and
transferring the friction force applied to the inboard and outboard brake pads to a carrier by abutting a carrier contact surface of the carrier with a backing plate contact surface of the backing plate of at least one of the inboard and outboard brake pads, wherein the carrier contact surface comprises a first top edge and the backing plate contact surface comprises a second top edge, wherein the second top edge is positioned below the first top edge and overlies the carrier contact surface.

14. The method of claim 13 wherein the backing plate has a first width and the friction material has a second width, wherein the first width is at least 40% of the second width.

15. The method of claim 14 wherein the first width is equal to or greater than 9 mm.

16. The method of claim 13 wherein transferring the friction comprises abutting a second carrier contact surface of the carrier with a second backing plate contact surface of the backing plate of the other of the inboard and outboard brake pads, wherein the second carrier contact surface comprises a third top edge and the second backing plate contact surface comprises a fourth top edge, wherein the third top edge is positioned below the fourth top edge.

17. The method of claim 16 further comprising a caliper housing supporting the carrier, wherein the second backing plate contact surface and/or fourth top edge has a minimum spacing from the caliper housing, wherein the minimum spacing is equal to or greater than 2 mm.

18. The method of claim 13 wherein the friction material is copper free.

19. The method of claim 13 wherein the backing plate comprises a top surface and a chamfered corner disposed between the backing plate contact surface and the top surface.
